(19) United States
(12) Patent Application Publication
(10) Pub. No.: US 2022/0282966 A1
(43) Pub. Date: Sep. 8, 2022

(54) THICKNESS MEASUREMENT DEVICE AND METHOD FOR MEASURING THICKNESS OF FIRST LAYER OF PLANT LEAF

(71) Applicant: National University Corporation Hokkaido University, Hokkaido (JP)

(72) Inventors: Yukihiro TAKAHASHI, Sapporo-shi, Hokkaido (JP); Tumendemberel BEGZSUREN, Sapporo-shi, Hokkaido (JP)

(21) Appl. No.: 17/628,758

(22) PCT Filed: Mar. 24, 2020
(86) PCT No.: PCT/JP2020/013087

§ 371 Date: Jan. 20, 2022

(30) Foreign Application Priority Data
Jul. 24, 2019 (JP) 2019-136105

(51) Int. Cl. G01B 11/06; A01G 7/00

(52) U.S. Cl. CPC G01B 11/0625; A01G 7/00; G01B 11/0641

(57) ABSTRACT

A thickness measurement device is provided for measuring a thickness of a first layer of an entire plant leaf including the first layer and a second layer, the first layer having an incident surface and an opposing surface opposing the incident surface, the second layer being in contact with the opposing surface of the first layer. The thickness measurement device includes: a light source that causes light of a predetermined wavelength λ to enter the incident surface as an incident light from an air layer at a predetermined incident angle θᵢ; a spectroscopic camera that receives a combined reflected light obtained by combining first and second reflected lights, and acquires a two-dimensional image including a light intensity of an S-polarized light component perpendicular to the incident surface among the combined reflected light; and a controller that calculates the thickness t of the first layer by using a predetermined equation.

### TECHNICAL FIELD

The present invention relates to a thickness measurement device and method for measuring the thickness of a living body or an object.

### BACKGROUND ART

An integument layer or exocarp layer, which is the outermost layer of a plant leaf, is covered with a wax-based cuticular layer that is several hundred nm to several microns thick. The cuticular layer is thought to prevent the entry of disease-causing bacteria and control transpiration, and its thickness changes depending on the health of the plant. However, because the thickness of the thin layer is less than the wavelength of visible light, it is impossible to measure the thickness accurately with an optical microscope. In the past, the thickness of the material has been estimated exclusively by an electron microscopy (TEM) (hereinafter referred to as “Conventional example 1) (See, for example, non-patent document 1).

### PRIOR ART DOCUMENTS

### Patent Document

Patent document 1: Japanese patent publication No. JP4084877B2

### Non-Patent Documents

Non-patent document 1: H. J. Ensikat et al., “Direct Access to Plant Epicuticular Wax Crystals by a New Mechanical Isolation Method,” International Journal of Plant Sciences, Volume 161, Number 1, January 2000.
Non-patent document 2: Sukita Nakahara, “The apparatus for Measuring the Rate of Perspiration by Near-Infrared Hygrometer,” Transactions of the Society of Instrument and Control Engineers, Vol. 18, No. 11, pp. 1099-1103, November 1982.
Non-patent document 3: Noriko Tsuruoka et al., “Development of Small Sweating Rate Meters and Sweating Rate Measurement during Mental Stress Load and Heat Load,” Biomedical Engineering, Vol. 54, No. 5, pp. 207-217, 2016.

### SUMMARY OF THE INVENTION

However, the electron microscopy cannot observe the living body as it is, and requires many steps and a great deal of time to replace materials. As a result, it is impossible to capture changes in thickness in the living state. In addition, because each of the materials is as small as a few millimeters, there is a limit to the representativeness of the entire leaf.

For example, a method of measuring the thickness of a thin film with a thickness of 200 nm or less (hereinafter referred to as “Conventional example 2”) is disclosed in Patent Document 1. In the film thickness measurement method, the following configuration is used to measure the film thickness of thin films of 200 nm or less accurately and with high throughput by using an optical interference film thickness measurement method without drastically changing the equipment configuration. Irradiated light from a light source is incident on a film on a substrate, which is the measurement target. The reflected light that causes interference from the film is reflected by the light receiving means while changing the incident angle of the irradiated light to the main surface of the film, and the reflected intensity of the P-polarized light that has passed through the deflection filter with the light transmission axis set in the surface direction where the optical axis meets the stage movement direction is measured. The film thickness of the aforementioned film is obtained from the reflection angle that takes the minimum value in the intensity variation of the measured reflected light.

However, when the thickness of the cuticular layer, which is the integument layer of the plant leaf and contains wax component, is measured by using the film thickness measurement method for thin films in the Conventional example 2 and then the reflection intensity of P-polarized light is measured, the absorption of P-polarized light waves in the cuticular layer and its inner layer is large. The absorption of light waves is large in the cuticular layer and its inner layer. In the case of the thin film thickness measurement method using the P-polarized light, there is a large absorption of P-polarized light waves in the cuticular layer and its inner layer. Therefore, a large reflection intensity cannot be obtained, and the thickness of the cuticular layer cannot be measured with sufficient accuracy.

In addition, the thickness of not only the cuticular layer, but also the thickness of each of living bodies and objects cannot be measured with higher accuracy than that of the conventional techniques.

The purpose of the present invention is to solve the above problems and to provide a thickness measurement device and method that can measure the thickness of a living body or an object more easily and with higher accuracy than that of the conventional techniques.

### Means for Solving the Problems of the Invention

According to the first aspect of the present invention, there is provided a thickness measurement device for measuring a thickness of a first layer of a living body or an object including the first layer and a second layer, where the first layer has an incident surface and an opposing surface opposing the incident surface, and the second layer is in contact with the opposing surface of the first layer. The thickness measurement device includes a light source, a light receiving device, and a controller. The light source causes light of a predetermined wavelength A to enter the incident surface as an incident light from an air layer at a predetermined incident angle θᵢ. The light receiving device receives a combined reflected light obtained by combining first and second reflected lights, and detects a light intensity of an S-polarized light component perpendicular to the incident surface among the combined reflected light. The controller is configured to calculates and outputs the thickness t of the first layer. The first reflected light is obtained such that the incident light is reflected at a reflection angle identical to the incident angle θᵢ at the incident surface. The second reflected light is obtained such that the incident light is refracted at a refraction angle θ₂ at the incident surface, is incident onto the first layer, and then, is reflected by the opposing surface of the first layer, and returns to the incident surface, and is refracted by the incident surface and outputted. The controller is configured to detect the light intensities of the S-polarized light components for each of the incident angles θᵢ while changing the incident angle θᵢ, searches for the incident angle θᵢ corresponding to a minimum value of the light intensities of the detected S-polarized light components, and calculates and outputs the thickness t of the first layer by using the following equation:

$$t = \frac{( m - \frac{1}{2} ) λ}{2 {n}_{1} cos ( {θ}_{2} )} , \qquad [ Euqation 1 ]$$

and

n₀×sin θᵢ=n₁×sin θ₂,

where m is a natural number,

n₁ is a refractive index of the air layer, and

n₂ is a refractive index of the first layer.

According to the second aspect of the invention, there is provided a thickness measurement method of measuring a thickness of a first layer of a living body or an object including the first layer and a second layer, where the first layer has an incident surface and an opposing surface opposing the incident surface, and the second layer is in contact with the opposing surface of the first layer. The thickness measurement method includes the steps of: causing light of a predetermined wavelength λ from a light source to enter the incident surface as an incident light from an air layer at a predetermined incident angle θᵢ; by a light receiving device, receiving a combined reflected light obtained by combining first and second reflected lights, and detects a light intensity of an S-polarized light component perpendicular to the incident surface among the combined reflected light; and by a controller, calculating and outputting the thickness t of the first layer. The first reflected light is obtained such that the incident light is reflected at a reflection angle identical to the incident angle θᵢ at the incident surface. The second reflected light is obtained such that the incident light is refracted at a refraction angle θ₂ at the incident surface, is incident onto the first layer, and then, is reflected by the opposing surface of the first layer, and returns to the incident surface, and is refracted by the incident surface and outputted. The controller is configured to detect the light intensities of the S-polarized light components for each of the incident angles θᵢ while changing the incident angle θᵢ, searches for the incident angle θᵢ corresponding to a minimum value of the light intensities of the detected S-polarized light components, and calculates and outputs the thickness t of the first layer by using the following equation:

$$t = \frac{( m - \frac{1}{2} ) λ}{2 {n}_{1} cos ( {θ}_{2} )} , \qquad [ Equation 2 ]$$

and

n₀×sin θᵢ=n₁×sin θ₂,

where m is a natural number,

n₁ is a refractive index of the air layer, and

n₂ is a refractive index of the first layer.

### Effect of the Invention

Therefore, according to the thickness measurement device and method of the present invention, the device and method can measure the thickness of the living body or the object more easily and with higher accuracy than that of the prior art.

### BRIEF EXPLANATION OF THE DRAWINGS

FIG. 1 is a block diagram of a configuration example of an integument layer thickness measurement device for measuring a thickness of an integument layer of a plant leaf.

FIG. 2A is a block diagram showing a detailed configuration example of a moving mechanism 6 of a light source 4 and a light receiving device 5 of the measurement device of FIG. 1.

FIG. 2B is a front view showing a configuration example of a light source device 20 of a modified embodiment.

FIG. 2C is a front view showing a configuration example of a light receiving device 30 of a modified embodiment.

FIG. 3 is a longitudinal cross-sectional view showing a measurement principle of the integument layer thickness measurement device of FIG. 1.

FIG. 4 is a graph of measurement results measured by using the integument layer thickness measurement device of FIG. 1, showing a reflectance to an incident angle θᵢ at the wavelength λ=460 nm.

FIG. 5A is a graph of measurement results measured on a pothos leaf by using the integument layer thickness measurement device of FIG. 1, showing a bi-directional reflectance (BRF) to an incident angle θᵢ at the wavelength λ=460 nm.

FIG. 5B is a graph of the thickness t versus a peak count value in the graph of FIG. 5A.

FIG. 6A is a graph of measurement results measured on coffee leaves by using the integument layer thickness measurement device of FIG. 1, showing the bi-directional reflectance (BRF) at the wavelength λ=460 nm.

FIG. 6B is a graph of measurement results measured on a coffee leaf by using the integument layer thickness measurement device of FIG. 1, showing the bi-directional reflectance (BRF) at the wavelength λ=478 nm.

FIG. 6C is a graph of measurement results measured on a coffee leaf by using the integument layer thickness measurement device of FIG. 1, showing a bi-directional reflectance (BRF) at the wavelength λ=492 nm.

FIG. 6D is a graph of measurement results measured on a coffee leaf by using the integument layer thickness measurement device of FIG. 1, showing a bi-directional reflectance (BRF) at the wavelength λ=510 nm.

FIG. 6E is a graph of measurement results measured on a coffee leaf by using the integument layer thickness measurement device of FIG. 1, showing a bi-directional reflectance (BRF) at the wavelength λ=525 nm.

FIG. 6F is a graph of measurement results measured on a coffee leaf by using the integument layer thickness measurement device of FIG. 1, showing a bi-directional reflectance (BRF) at the wavelength λ=535 nm.

FIG. 7 is a photographic image of a cross section of a coffee leaf taken by using an electron microscope (TEM).

FIG. 8 is a magnified photographic image of the photographic image in FIG. 7.

FIG. 9A is a photographic image of a cross-section of a coffee leaf taken by sequential magnification by using the electron microscope (TEM).

FIG. 9B is a photographic image of a cross-section of a coffee leaf taken at sequential magnification by using the electron microscope (TEM).

FIG. 9C is a photographic image of a cross section of a coffee leaf taken by sequential magnification by using the electron microscope (TEM).

FIG. 9D is a photographic image of a cross section of a coffee leaf taken by sequential magnification by using the electron microscopy (TEM).

FIG. 10 is a photographic image of a cross-section of the cuticle layer containing wax component of a pothos leaf, taken by using the electron microscope (TEM).

FIG. 11 is a longitudinal cross-sectional view showing a measurement principle of the thickness measurement device of a further modified embodiment.

### BEST MODE FOR IMPLEMENTING THE INVENTION

Embodiments of the present invention will be described below with reference to the drawings. The same numerical reference is attached to the same or similar components.

### Principle of Thickness Measurement Method

First of all, the principle of the method of measuring a thickness of an integument layer of each of plant leaves is described below.

This method of measuring the thickness of the integument layer estimates a thickness of a cuticle layer from the interference caused by light rays reflected from the upper surface (or top surface) and lower surface (a boundary surface between the cuticle layer and the leaf cells) of the cuticle layer, by measurement using polarized light at a specific wavelength.

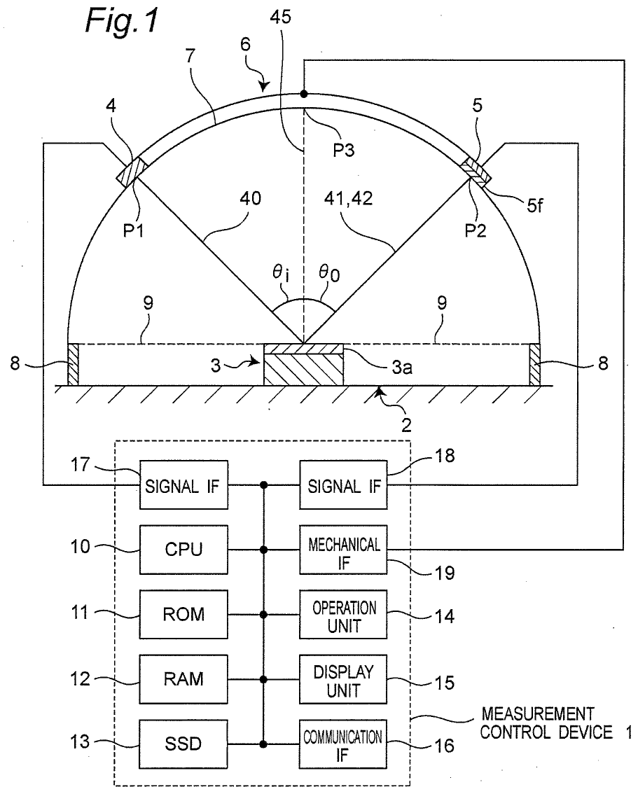

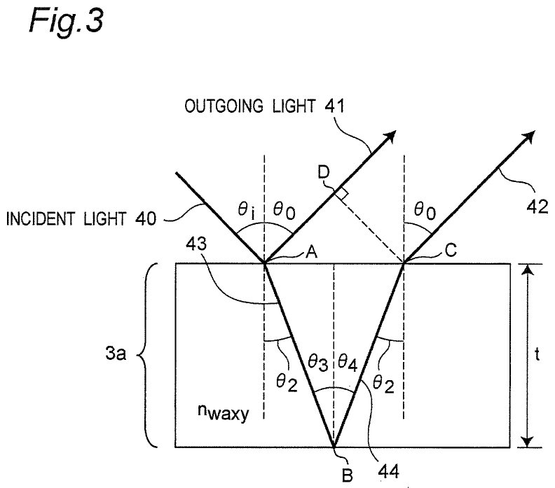

FIG. 3 is a longitudinal cross-sectional view showing a measurement principle of an integument layer thickness measurement device of FIG. 1, which will be described later in this section. In FIG. 3, 3a denotes a cuticular layer, which is an integument layer of a plant leaf, and has a thickness t.

Referring to FIG. 3, the incident light 40 from a light source enters the position A on the upper surface of the cuticle layer 3a at an incident angle θᵢ, and then, is reflected at the upper surface (incident surface) of the cuticular layer 3a at a reflection angle θₒ (=θᵢ), which is the same angle in the opposite direction, and is emitted as an outgoing light 41. In this case, the phase of the light wave at that time is shifted by 180 degrees. Some of the incident light 40 is refracted into the cuticular layer 3a at a refraction angle θ₂ to satisfy the Snell's law in the following equation (1), and enters as a refracted light 43:

nₐᵢᵣ×sin θᵢ=n_{waxy}×sin θ₂ (1),

where nₐᵢᵣ is a refractive index of the atmosphere (being approximately equal to 1), and n_{waxy} is a refractive index of the cuticular layer 3a containing the wax component.

The incident light 43 entering into the cuticular layer 3a passes through the interior of the cuticular layer 3a. Then, the incident light 43 is reflected at the position B on the lower surface of the cuticular layer 3a at the incident angle θ₃ and the reflection angle θ₄ (=θ₃), and the phase of the light wave at that time is shifted by 180 degrees. The reflected light 44 reflected at the position B passes through the interior of the cuticular layer 3a again, and is refracted at the position C, and is emitted at the same refraction angle θₒ as the reflection angle θₒ at the position A. The outgoing light 42 becomes the outgoing light in the same direction as that of the outgoing light 41, and the outgoing light 42 is combined with the outgoing light 41, and is observed as “a combined reflected light” by the light receiving device.

Therefore, the two outgoing lights 41 and 42 reflected from the upper and lower surfaces of the cuticular layer 3a are in opposite phases to each other when they are combined. In other words, the condition under which the intensities of these two rays 41 and 42 show a peak in the negative direction is expressed by the following equation:

2×n_{waxy}×t×cos(θ₂)=(m−½)λ (2),

where t is the thickness of the cuticular layer 3a, m is a natural number, and λ is the wavelength of light waves in the atmosphere. Solving the Equation (2) for the thickness t, we obtain the following equation:

$$\begin{matrix}[ Equation 3 ] & \\ t = \frac{( m - \frac{1}{2} ) λ}{2 {n}_{waxy} cos ( {θ}_{2} )} & ( 3 )\end{matrix}$$

In other words, if we can measure the refraction angle θ₂ at which the intensity peaks in the negative direction due to interference, we can estimate the thickness t of the cuticle layer 3a.

In the embodiment, while changing the incident angle θᵢ to the plant leaf, the measurement device measures the light intensity of the S-polarized light component perpendicular to the incident surface of the outgoing light reflected at the reflection angle θₒ of the same angle as the incident angle θᵢ, and examines the angle with the minimum value. The significance of measuring the light intensity of the S-polarized light component will be explained in detail later. This measurement method has high advantages over the measurement method using an electron microscope in conventional example 1 in the following two points:

(1) the plant can be measured while it is still alive; and

(2) if a two-dimensional image can be acquired with a spectroscopic camera, it is possible to estimate the thickness t of the cuticle layer 3a over the entire leaf area.

In addition, the polarization component to be measured is different from that of the thin film thickness measurement method of the Conventional Example 2, and the thickness t can be measured with higher accuracy as described in detail below.

### Configuration of the Thickness Measurement Device

Next, the configuration of the plant leaf integument layer thickness measurement device is described below.

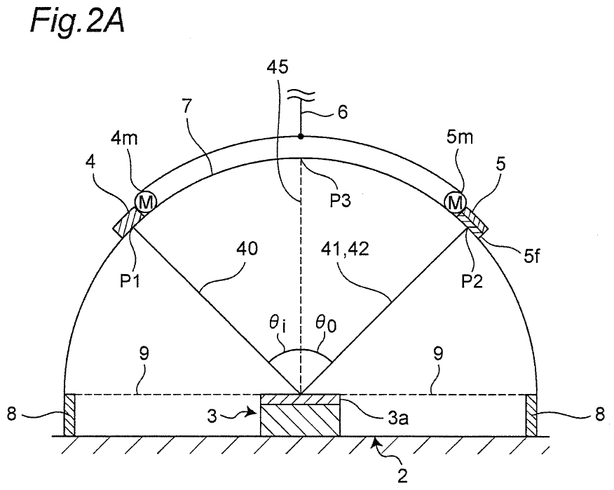

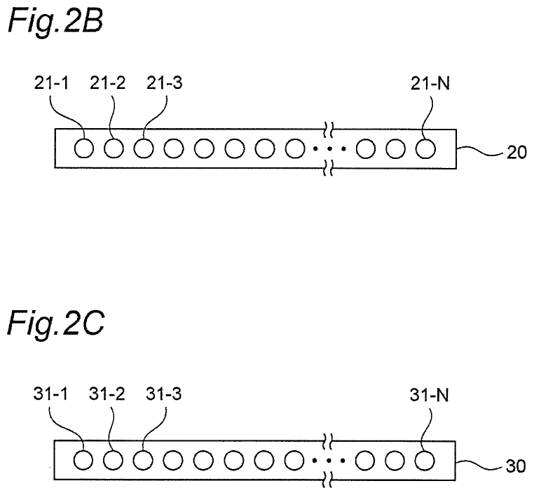

FIG. 1 is a block diagram showing a configuration example of the integument layer thickness measurement device of a plant leaf according to an embodiment, and FIG. 2A shows a detailed configuration example of a movement mechanism 6 of the light source 4 and the light receiving device 5 of the measurement device of FIG. 1.

Referring to FIG. 1, the measurement control device 1 controls the entire measurement process of the measurement device, and is configured to include a CPU (Central Processing Unit) 10, a ROM (Read Only Memory) 11, a RAM (Random Access Memory) 12, an SSD (Solid State Drive) 13, an operation unit 14, a display unit 15, a communication interface (hereinafter referred to as a “communication IF”) 16, signal interfaces (hereinafter referred to as “signal IFs”) 17 and 18, and a mechanism interface (hereinafter referred to as a mechanism IF) 19.

The CPU 10 is a controller (control unit) that controls each of the components of the measurement control device 1, and executes the measurement process of the measurement device. The ROM 11 stores in advance a program of the measurement process of the measurement control device 1 and the data necessary to execute the same program. The RAM 12 temporarily stores measurement data, etc. when the CPU 10 executes the measurement process of the measurement device. The SSD 13 stores the additional program of the measurement process of the measurement control device 1 and the data necessary to execute the same program, as well as the measurement data. The operation unit 14 includes, for example, a keyboard and a mouse, and is provided for inputting instructions, etc. when executing the measurement process of the measurement control unit 1. The display section 15 displays the measurement results, etc. when the measurement process of the measurement control unit 1 is executed. The communication IF 16 transmits the measurement results to a cloud or server device via a network such as the Internet. The signal IF 17 transmits control signals such as ON/OFF signals from the measurement control device 1 to the light source 4. The signal IF 18 receives a signal indicating the light-receiving intensity signal level from the light-receiving device 5. The mechanism IF 19 transmits control signals to control the operation of the moving mechanism 6 that controls the positions of the light source 4 and the light receiving device 5. The mechanism IF 19 sends control signals to control the operation of the moving mechanism 6 that controls the positions of the light source 4 and the light receiving device 5, and receives ACK signals and other reply signals from the moving mechanism 6.

A plant leaf 3 to be measured is placed on a table 2, and the leaf 3 has a cuticle layer 3a, which is an integument layer, on its upper surface. A virtual horizontal line passing through the upper surface of the cuticle layer 3a is indicated by the numerical reference 9. The moving mechanism 6 with a semicircular rail 7 is supported by a support member 8 on the placing stand 2.

As shown in FIG. 2A, the rail 7 is connected to a stepping motor 4m, which moves the light source 4, via a first gear, and the rail 7 is connected to the stepping motor 5m, which moves the light receiving devices, via a second gear. The light source 4 is connected to the rail at the position P1 of the rail 7 so that the incident light 40, which is the light source light from the light source 4, enters the upper center of the plant leaf 3 at an incident angle θᵢ. The light receiving device 5 has a polarizing filter 5f on its front surface that selectively passes S-polarized or P-polarized light, and the light receiving device 5 is installed at the position P1 of the rail 7 so to receive the outgoing lights 41 and 42 emitted from the center of the upper surface of the plant leaf 3 at an outgoing angle θₒ. The reference line 45 of the zenith angle extends from the center of the upper surface of the plant leaf 3 toward the uppermost position P3 of the semicircular shaped rail 7. In this case, the plant leaf 3 is placed on the placing stand 2 so that the center of the upper surface of the plant leaf 3 is generally located at the center of the circle of the rail 7. In this case, the light from the light source 4 is emitted under the control of the CPU 10 of the measurement control unit 1. Then, the moving mechanism 6 is controlled under control of the CPU 10 of the measurement control device 1, while the emitted light 41 and 42 emitted from the upper surface of the plant leaf 3 is received by the light receiving device 5 and its intensity is measured, and so that the position P1 of the light source 4 and the position P2 of the light receiving device 5 are moved sequentially toward the position P3 such that the incident angle θᵢ=the outgoing angle θₒ.

As explained above, according to the present embodiment, while changing the incident angle θᵢ to the plant leaf 3, the light intensities of the S-polarized light components perpendicular to the incident surface of the outgoing light reflected at the reflection angle θₒ of the same angle as the incident angle θᵢ are measured, and then, the angle with the minimum value is examined to be searched. In this way, the thickness t of the cuticle layer 3a can be estimated while the plant is still alive.

### Modified Embodiments

In the above embodiment, the moving mechanism 6 controls the position P1 of the light source 4 and the position P2 of the light receiving device 5 so that the incident angle θᵢ=the outgoing angle θₒ. The present invention is not limited to this. Instead of the moving mechanism 6 of FIGS. 1 and 2A, the following light source device 20 and light receiving device 30 may be used.

FIG. 2B is a front view showing a configuration example of the light source device 20 of the modified embodiment. Referring to FIG. 2B, the light source device 20 has an arc shape along the rail 7, and a plurality of light sources 21-1 to 21-N (collectively indicated with a numerical reference 21) are placed at predetermined intervals. Any one of the multiple light sources 21-1 to 21-N of the light source 21 is selectively emitted.

FIG. 2C is a front view showing a configuration example of a light receiving device 30 of a modified embodiment. Referring to FIG. 2C, the light receiving device 30 has an arc shape along the rail 7, and a plurality of light receiving devices 31-1 to 31-N (collectively indicated with a numerical reference 31) are placed at predetermined intervals. Any one of the plurality of light receiving devices 31-1 to 31-N of the light is selectively received by one light receiving device 31.

In this case, with respect to the position P1 of the light source 21 and the position P2 of the light receiving device 31, the CPU 10 of the measurement control unit 1 controls the position P1 of the light source 21 and the position P2 of the light receiving device 31 so that the incident angle θᵢ=the outgoing angle θₒ.

In the above embodiment, the light receiving devices 5 and 31 are used. However, the present invention is not limited thereto, and the thickness t of the cuticle layer 3a can be estimated over the entire upper surface of the leaf by measuring the entire upper surface of the plant leaf 3 by using an imaging device such as a spectral camera.

Furthermore, in the above embodiment, the light receiving device 5 is provided with the polarization filter 5f. However, the present invention is not limited to this, and in order to remove noise outside a predetermined band, a band pass wavelength filter, which passes only the band to be received, may be provided in front of the light receiving device 5.

### EXAMPLES

### Measurement Results Using the Thickness Measurement Device

The following is a description of the measurement results obtained by the inventors by using the thickness measurement device shown in FIG. 1.

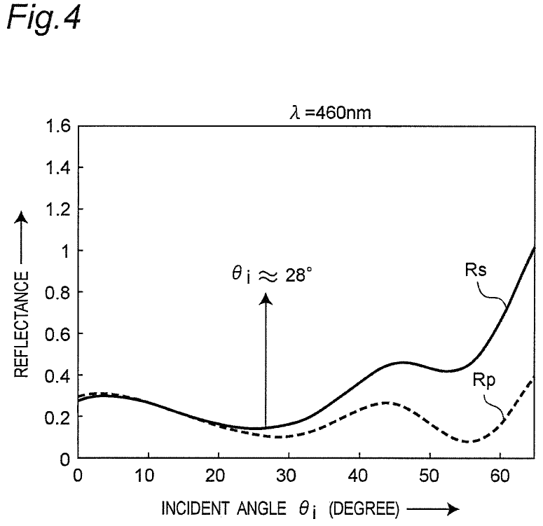

FIG. 4 shows measurement results of a thickness of a coffee leaf by using the measurement device shown in FIG. 1, by irradiating the surface of the leaf with a light of wavelength 460 nm at an incident angle θᵢ, and by measuring the reflected light intensity separately with the S-polarized component (Rs: perpendicular to the incident surface) and the P-polarized component (Rp: perpendicular to the incident surface) at an exit angle θₒ (=θᵢ) to measure the reflectance. As can be seen from FIG. 4, the reflectance Rs of the S-polarized component is larger than that of the P-polarized component, Rp, and reaches the minimum at about 28°. If the refractive index of the cuticular layer 3a is 1.5, then the thickness t of the cuticular layer 3a can be calculated as 403 nm (m=3).

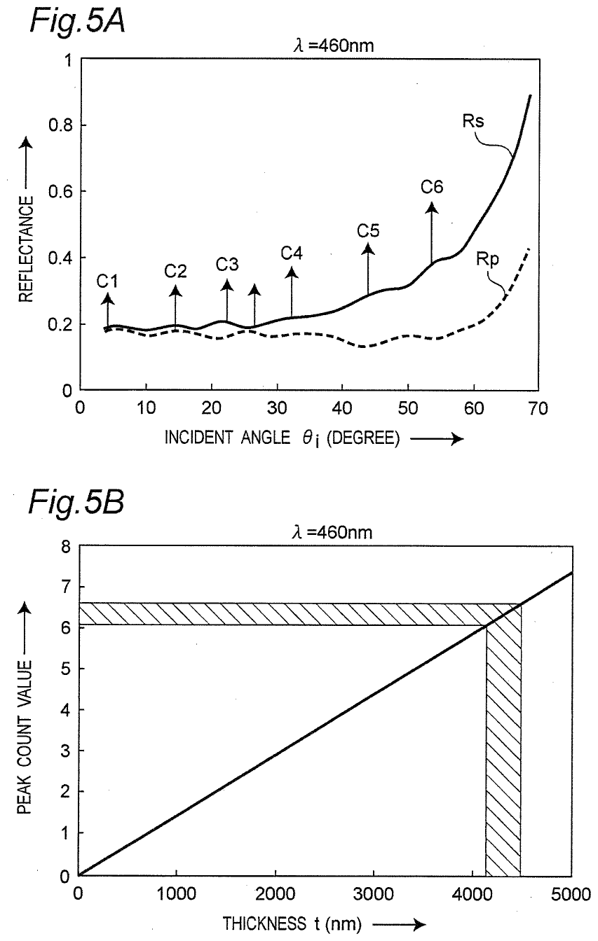

FIG. 5A is a graph of measurement results measured on pothos leaves by using the integument layer thickness measurement device of FIG. 1, showing a bi-directional reflectance (BRF) to an incident angle θᵢ at λ=460 nm. FIG. 5B is a graph of a thickness t versus a peak count value in the graph of FIG. 5A.

In other words, FIGS. 5A and 5B each show the relationship among the mirror reflection measurements of pothos leaves at a wavelength of 450 nm, the peak numbers of structural interferences, and the thickness of the cuticular layer containing the wax component. In particular, FIG. 5A shows a frequency of structural interferences within the measurement limit, and the thickness t can be determined depending on the number of occurrences.

This type of effect is not only seen in the mirror reflections, but also in the BRF measurements of coffee plant leaves. In this case, the strongly observed structural or constructive peaks, which can be seen at wavelengths from 460 nm to 550 nm, are much larger than the refractive index of the cuticular layer, which contains the wax component of the mesophilic layer at this optical wavelength. From strawberry leaves, we could not see any interference waves.

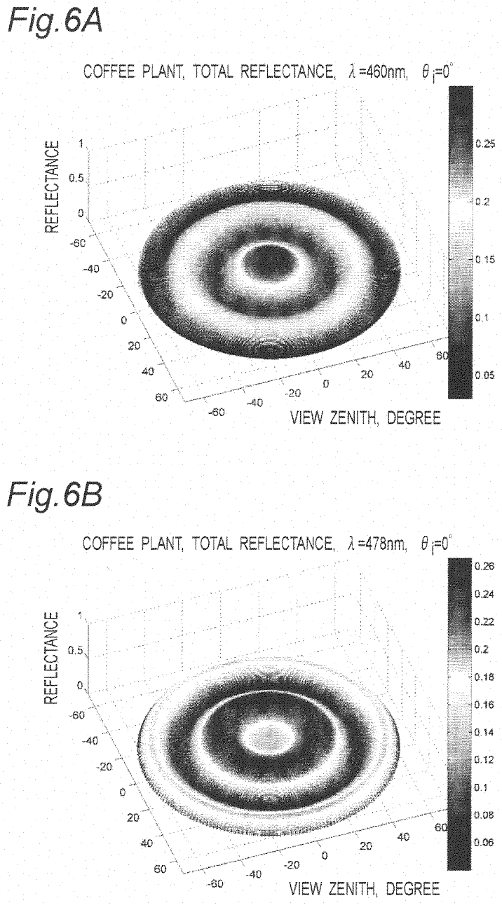

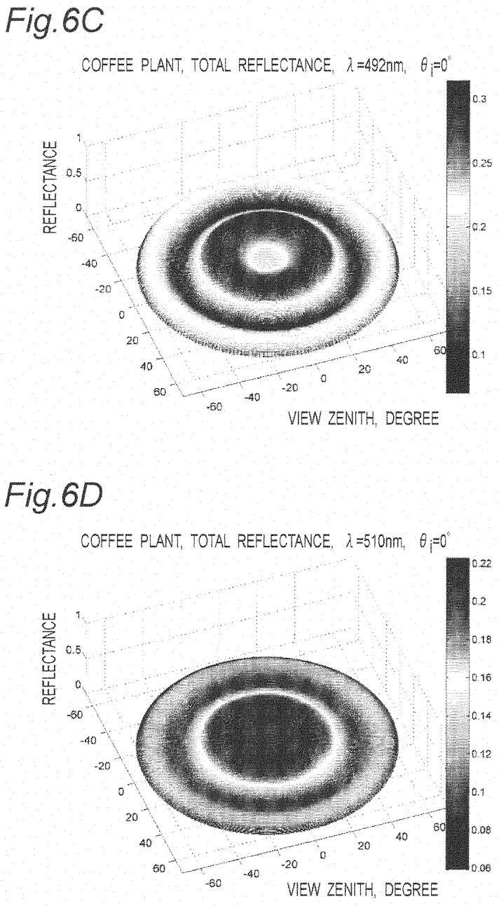

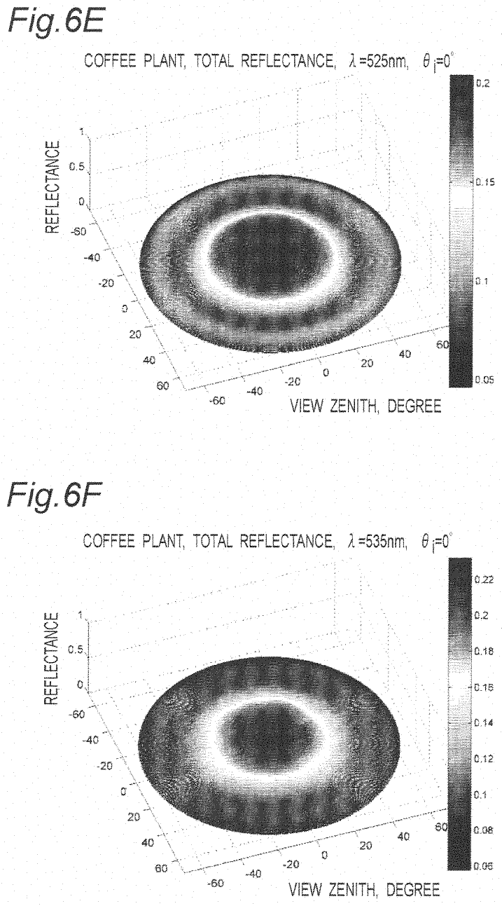

FIGS. 6A to 6F show graphs of measurement results measured on coffee leaves by using the integument layer thickness measurement device in FIG. 1, respectively, showing bi-directional reflectances (BRF) at the wavelengths λ=460 nm, 478 nm, 492 nm, 510 nm, 492 nm, 510 nm, 525 nm, and 535 nm.

As can be seen from FIGS. 6A to 6F, the bi-directional reflectances (BRF) of coffee leaves at different wavelengths are shown, and the destructive interference peak moved towards the higher observed zenith angle, which is due to thin film interference.

In addition, the following photographic images were taken by the inventors by using an electron microscope (TEM).

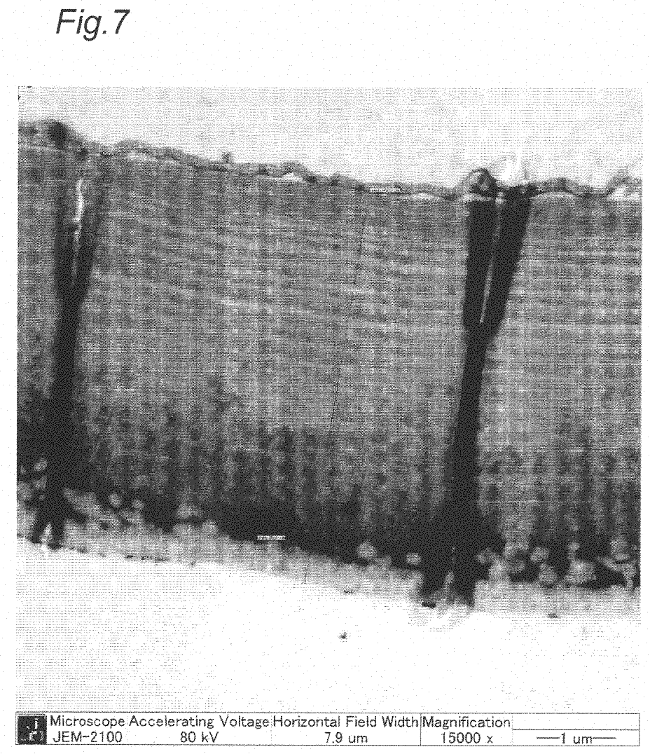

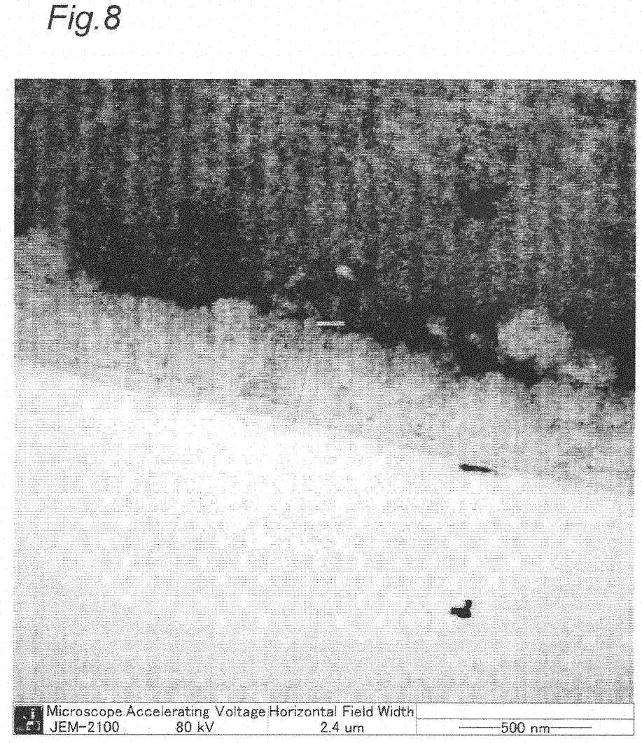

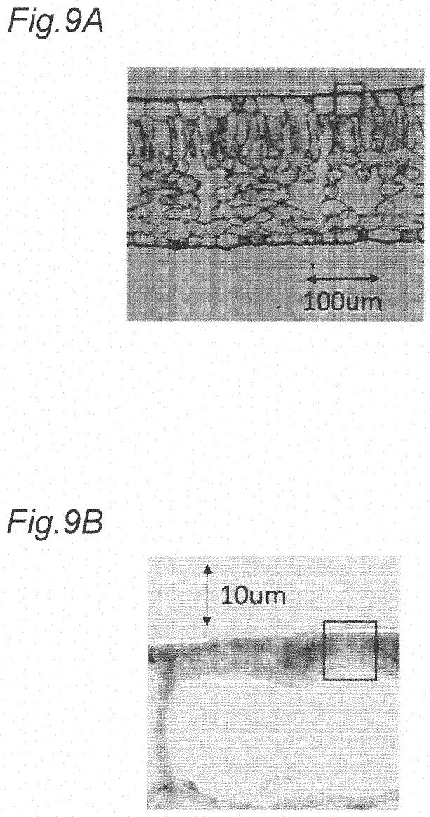

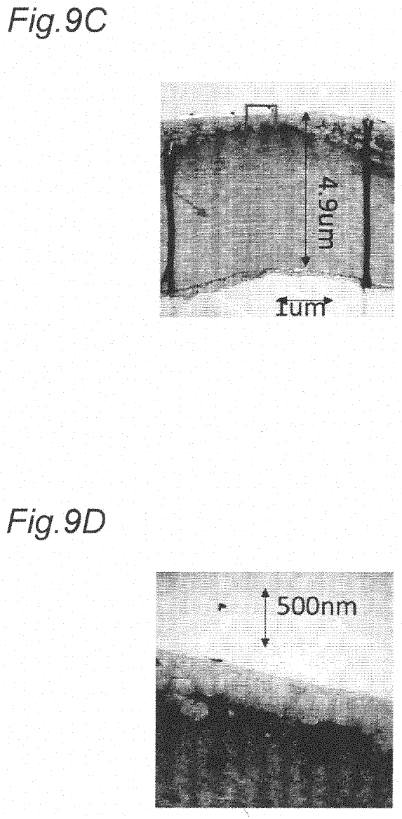

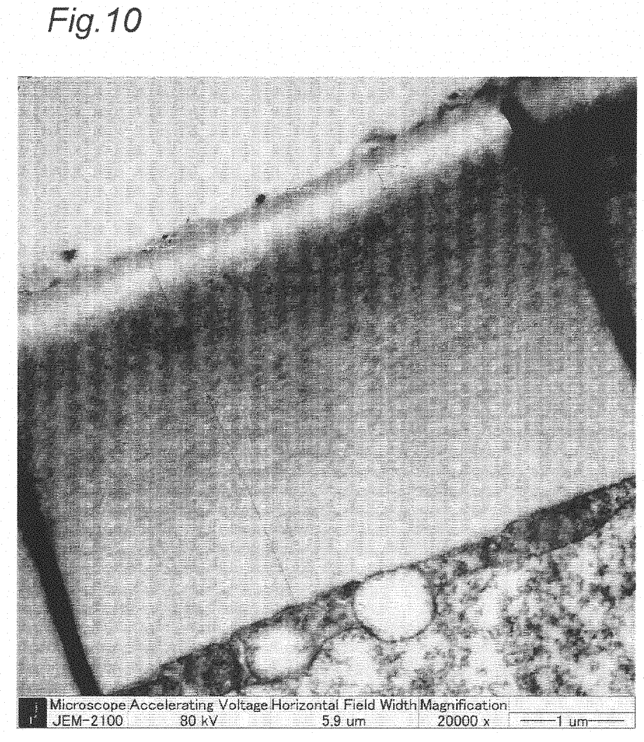

FIG. 7 is a photographic image of a cross section of a coffee leaf taken by using the electron microscope (TEM). In addition, FIG. 8 is an enlarged photographic image of the photographic image in FIG. 7. Further, FIGS. 9A to 9D are photographic images of the cross-section of a coffee leaf taken by sequential magnification by using the TEM. FIG. 10 is a photographic image of a cross section of a cuticle layer of a pothos leaf containing wax component, taken by using the TEM.

Referring to FIG. 7, a transmission electron microscope (TEM) image is shown, which shows a cross-section of the thickness of the cuticular layer containing the wax component of a coffee leaf (on the axial side), including several sections. In this case, the thickness of the uppermost section layer was about 400 nm. FIG. 8 shows an enlargement of the image in FIG. 7, which shows am uppermost section layer of the cuticular layer (coffee) containing the wax component, with a thickness of about 400 nm. In FIGS. 9A to 9D, we can see that the cross section of the coffee leaf is enlarged in steps. FIG. 10 shows an image of the cuticular layer containing the wax component of the pothos leaf, with a thickness of about 4.2 μm.

As can be seen from FIGS. 7 to 10, optical measurements and calculations show that the thickness of the cuticular layer containing the wax component of coffee leaves was about 403 nm, and the thickness of the cuticular layer of Pothos was 4.2 μm. This could then be checked by using electron microscopy, and the two thicknesses determined from each other were found to be consistent.

### Differences Between the Embodiments and the Patent Document 1

In the present embodiment, the thickness of the cuticular layer 3a is measured by using the light intensity of the S-polarized light component. In contrast, the Patent document 1 discloses the measurement of the thickness of the thin film layer of an object by using the light intensity of the P-polarized light component. These differences are explained below.

The invention of the Patent document 1 is based on the description in FIGS. 5 and 6 thereof, and paragraph 0062 thereof, and in particular, the invention of the Patent document 1 includes the following features:

(A) the reflected light to be measured is P-polarized light;

(B) the minimum value of the intensity variation of the reflected light is used; and

(C) the measurement target is a film with a thickness of 200 nm or less.

The invention of the Patent document 1 claimed that the method has the excellent effect of measuring the object to be measured with an accuracy of about ±3% (See, for example, paragraph 0062; the Patent document 1 (See, for example, paragraph 0062; See also the opinion letter dated Nov. 2, 2007 in the examination process of the application for the Patent document 1).

On the other hand, the present embodiment differs from the Patent document 1 in that it is characterized, in particular, by the following:

(A) The reflected light to be measured is an S-polarized light. (As is clear from the electron microscope measurements described above, the S-polarized component is presumed to be composed mainly of light that passes through and is reflected from the cuticular layer 3a twice. On the other hand, the P-polarized light component is estimated to be mainly composed of the light component that is reflected back from the cuticular layer 3a and the underside of the main leaf layer below the cuticular layer 3a. Most of the cuticular layer 3a contains cells with a refractive index of 1.5, while the main layer of the leaf contains cells with a refractive index of 1.5 and intercellular spaces with a refractive index of 1.0, so the main layer of the leaf has a refractive index of about 1.2 to 1.4. It is clear from FIG. 4 of the Patent document 1 that the refractive index of the membrane 42 in FIG. 4 is smaller than that of its substrate 41. On the other hand, the refractive index of the cuticular layer 3a is larger than the refractive index of the main layer of the leaf, and then, the structures of the film and silicon substrate in the Patent document 1 are completely different from the structures of the cuticular layer 3a and the main layer of the leaf in the present embodiment.)

(B) While changing the incident angle of the incident light, the minimum value of the light intensities of the combined reflected lights for the incident angle is used.

(C) The measurement target is the integument layer (such as a cuticular layer) of plant leaves. (As an example of thickness, the thickness of the cuticular layer of a coffee leaf is about 403 nm, and the thickness of the cuticular layer of a pothos is 4.2 μm). In the Patent document 1, the thickness of the film on the silicon substrate is targeted.

### Summary of Embodiments, Etc

As explained above, according to a thickness measurement device for measuring a thickness of an integument layer of a plant leaf of the embodiments and its modified embodiments, the thickness measurement device is characterized by including:

a light source that causes light of a predetermined wavelength λ to enter the incident surface of the plant leaf as an incident light from an air layer at a predetermined incident angle θᵢ;

a light receiving device that receives a combined reflected light obtained by combining first and second reflected lights, and detects a light intensity of an S-polarized light component perpendicular to the incident surface among the combined reflected light; and

a controller configured to calculates and outputs the thickness t of the first layer,

wherein the first reflected light is obtained such that the incident light is reflected at a reflection angle identical to the incident angle θᵢ at the incident surface of the plant leaf,

wherein the second reflected light is obtained such that the incident light is refracted at a refraction angle θ₂ at the incident surface of the plant leaf, is incident onto the integument layer of the plant leaf, and then, is reflected by the opposing surface of the integument layer of the plant leaf, and returns to the incident surface of the plant leaf, and is refracted by the incident surface of the plant leaf and outputted, and

wherein the controller is configured to detect the light intensities of the S-polarized light components for each of the incident angles θᵢ while changing the incident angle θᵢ, searches for the incident angle θᵢ corresponding to a minimum value of the light intensities of the detected S-polarized light components, and calculates and outputs the thickness t of the first layer by using the following equation:

$$t = \frac{( m - \frac{1}{2} ) λ}{2 {n}_{waxy} cos ( {θ}_{2} )} , \qquad [ Equation 4 ]$$

and

nₐᵢᵣ×sin θᵢ=n_{waxy}×sin θ₂,

where m is a natural number,

nₐᵢᵣ is a refractive index in the atmosphere, and

n_{waxy} is a refractive index of the integument layer.

In this case, the thickness measurement device further includes a moving mechanism that moves the light source and the light receiving device so that the incident angle θᵢ and the outgoing angle of the first and second reflected lights are the same as each other under the control of the controller.

In addition, the thickness measurement device for measuring the thickness of the integument layer of the plant leaf includes:

a plurality of light sources; and

a plurality of light receiving devices,

wherein the controller detects the light intensities of the S-polarized light components for each of the changed incident angles θᵢ while changing the incident angle θᵢ, by turning on one of the plurality of light sources sequentially and selectively to use a turned-on light source as a light source for being incident on the incident surface of the plant leaf, and by turning on one of the plurality of light receiving devices sequentially and selectively to use a turned-on light receiving device as a light receiving device for detecting the combined reflected light.

In this case, the light receiving device includes a polarization filter that detects the S-polarized light component perpendicular to the incident surface among the combined reflected light.

As explained above, the thickness measurement device and method for measuring the thickness of the integument layer of the plant leaf can measure the thickness of the integument layer of the plant leaf more easily and with higher accuracy than that of the conventional cases. This makes it possible to measure the nutritional status of the plants in an extremely simple manner.

### Further Modified Embodiments

The above embodiments and their modified embodiments describe the integument layer thickness measurement device and method for measuring the thickness of the integument layer of the plant leaf, which is the thickness of the cuticular layer containing wax component of the plant leaf. However, the invention is not limited to this, and can also be applied to devices for detecting the thickness and conditions of the skin surface layer of animals each including the human body, the amount of perspiration from animals, the skin cell layer of animals, or the epidermal cell layer of animals and plants. A thickness measurement device for measuring the thickness of a living body or an object will be described below.

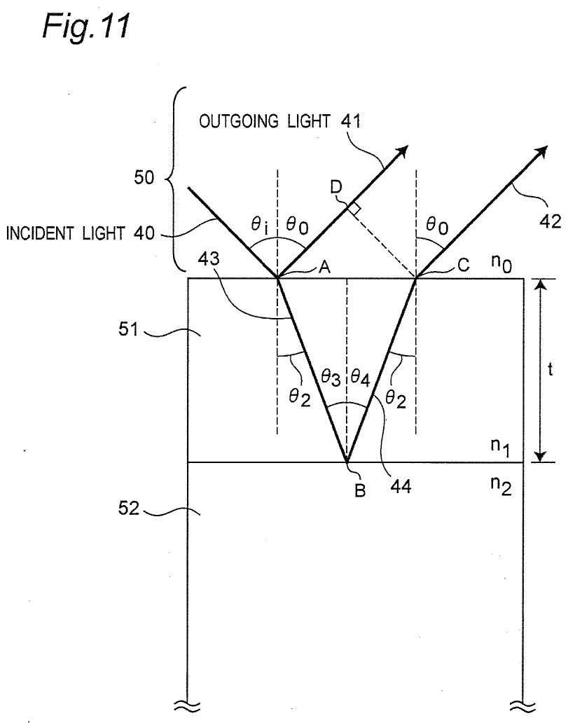

FIG. 11 is a longitudinal cross-sectional view showing a measurement principle of a thickness measurement device of a further modified embodiment. In FIG. 11, the same numerical reference is attached to the same items as in FIG. 3.

FIG. 11 shows a measurement principle of a thickness measurement device for measuring the thickness t of the first layer 51 of a living body or an object, where the living body or the object includes the first layer 51 (the outermost layer in contact with the air layer 50) having an incident surface and an opposing surface, and a second layer 52 in contact with the opposing surface of the first layer 51.

Referring to FIG. 11, by using the measurement device of FIG. 1, light of a predetermined wavelength λ is emitted from a light source 4 at a predetermined incident angle θᵢ from the air layer 50 to the position A of the incident surface of the first layer 51. The light receiving device 5 of FIG. 1 receives a combined reflected light obtained by combining the following outgoing light 41 and the following outgoing light 42, and detects the light intensity of the S-polarized light component perpendicular to the incident surface among the combined reflected light:

(1) the outgoing light 41 which is a first reflected light that is reflected at the incident surface at the same reflection angle θₒ as the incident angle θᵢ; and

(2) the light is refracted at the refraction angle θ₂ at the incident surface and incident on the first layer 51, and thereafter, the incident light is incident at the position B on the opposite side of the first layer 51 (or the upper side of the second layer 52) at the incident angle θ₃, the same incident light is reflected at the angle θ₄ to return to the incident surface, and is incident to the position C of the incident surface at the incident angle θ₂. Then the incident light is refracted at the refraction angle or outgoing angle θ₀ to output or emit the light, which is the outgoing light 42 that is the second reflected light.

In this way, the conditions, under which the incident light is incident to the light receiving device 5 by allowing the incident light to be incident, be refracted and reflected etc., are expressed by the following equation:

n₀<n₁<n₂ (4),

where n₀ is a refractive index of the air layer 50, n₁ is a refractive index of the first layer 51, and n₂ is a refractive index of the second layer.

The measurement control device 1 of FIG. 1 detects the light intensity of the S-polarized light component for each changed incident angle θᵢ while changing the incident angle θᵢ, searches for the incident angle θᵢ corresponding to the minimum value of the light intensity of the detected S-polarized light component, and can calculates and outputs the thickness t of the first layer 51 by using the following equation similar to Equation (3):

$$\begin{matrix}[ Equation 5 ] & \\ t = \frac{( m - \frac{1}{2} ) λ}{2 {n}_{1} cos ( {θ}_{2} )} , & ( 5 )\end{matrix}$$

and

n₀×sin θᵢ=n₁×sin θ₂ (6),

where m is a natural number, and the natural number m corresponds to the wavenumber of the incident light of wavelength λ when the incident light passes through the first layer 51. In order to calculate the thickness t of the first layer 51 with high accuracy, the natural number m is preferably 1, 2 or 3. As is clear from the relationship between the wavelength λ of the incident light and the thickness t in Equation (5), it is necessary to select the wavelength λ of the incident light so that the numerical value on the right side of equation (5) is substantially equal to the thickness t (about the same order).

As explained above, the present modified embodiment can measure the thickness of the first layer 51 of a living body or human body more easily and with higher accuracy than that of the prior art.

In addition, it is also clear from the Non-patent documents 2 and 3 that, we can find such plots that the perspiration rate per minute of a human body is 0.05 to 0.5 [mg/min/cm²], for example. Assuming that the specific gravity of sweat is 1 g/cm³, the thickness t of the surface layer of the human body can be converted to 0.5 to 5 μm. In other words, if we measure the thickness t of the skin surface layer of the human body by using the measurement device shown in FIG. 1, and we assume that the specific gravity of sweat is 1 g/cm³, the amount of perspiration of the human body can be calculated. In other words, the measurement device shown in FIG. 1 can be used as a sweat meter for animals such as the human body.

As described in detail above, the thickness measurement device and method of the present invention can measure the thickness of the first layer of the living body or the object more easily and with higher accuracy than that of the prior art. This makes it possible to measure the growth state, perspiration rate, etc. of a living body or other object.

### EXPLANATION OF NUMERICAL REFERENCES

1: Measurement control device
2: Placing stand
3: Plant leaf
3a: Cuticle layer
4: Light source
4m: Stepping motor
5: Light receiving device
5m: Stepping motor
6: Moving mechanism
7: Rail
8: Support member
9: Virtual horizontal line
10: CPU
11: ROM
12: RAM
13: SSD
14: Operation Unit
15: Display unit
16: Communication interface (Communication IF)
17 and 18: Signal interface (Signal IF)
19: Mechanism interface (Mechanism IF)
20: Light source device
21-1 to 21-N: Light source
30: Light receiving device
31-1 to 31-N: Light receiving device
40: Incident light
41 and 42: Outgoing light
43: Refracted light
44: Reflected light
50: Air layer
51: First layer of living body or object
52: Second layer of living body or object
A to D and P1 to P3: Position

1. A thickness measurement device for measuring a thickness of a first layer of an entire plant leaf including the first layer and a second layer, the first layer having an incident surface and an opposing surface opposing the incident surface, the second layer being in contact with the opposing surface of the first layer, the thickness measurement device comprising:
a light source that causes light of a predetermined wavelength λ to enter the incident surface as an incident light from an air layer at a predetermined incident angle θᵢ;
a spectroscopic camera that receives a combined reflected light obtained by combining first and second reflected lights, and acquires a two-dimensional image including light intensity of an S-polarized light component perpendicular to the incident surface among the combined reflected light; and
a controller configured to calculates and outputs the thickness t of the first layer,
wherein the first reflected light is obtained such that the incident light is reflected at a reflection angle identical to the incident angle θᵢ at the incident surface,
wherein the second reflected light is obtained such that the incident light is refracted at a refraction angle θ₂ at the incident surface, is incident onto the first layer, and then, is reflected by the opposing surface of the first layer, and returns to the incident surface, and is refracted by the incident surface and outputted, and
wherein the controller is configured to acquire the two-dimensional image including the light intensities of the S-polarized light components for each of the incident angles θᵢ while changing the incident angle θᵢ, to search for the incident angle θᵢ corresponding to a minimum value of the light intensities of the detected S-polarized light components, and to calculate and output the thickness t of the first layer of the entire plant leaf by using the following equation:
$$t = \frac{( m - \frac{1}{2} ) λ}{2 {n}_{1} cos ( {θ}_{2} )} , \qquad [ Equation 1 ]$$
and
n₀× sin θᵢ=n₁×sin θ₂,
where m is a natural number,
n₁ is a refractive index of the air layer, and
n₂ is a refractive index of the first layer.

2-3. (canceled)

4. The thickness measurement device as claimed in claim 1,
wherein the spectroscopic camera includes a polarization filter that detects the S-polarized light component perpendicular to the incident surface among the combined reflected light.

5. The thickness measurement device as claimed in claim 1,
wherein the first layer is a cuticular layer, which is an integument layer.

6-8. (canceled)

9. A thickness measurement method of measuring a thickness of a first layer of an entire plant leaf including the first layer and a second layer, the first layer having an incident surface and an opposing surface opposing the incident surface, the second layer being in contact with the opposing surface of the first layer, the thickness measurement method comprising the steps of:
causing light of a predetermined wavelength λ from a light source to enter the incident surface as an incident light from an air layer at a predetermined incident angle θᵢ;
by a spectroscopic camera, receiving a combined reflected light obtained by combining first and second reflected lights, and acquiring a two-dimensional image including a light intensity of an S-polarized light component perpendicular to the incident surface among the combined reflected light; and
by a controller, calculating and outputting the thickness t of the first layer,
wherein the first reflected light is obtained such that the incident light is reflected at a reflection angle identical to the incident angle θᵢ at the incident surface,
wherein the second reflected light is obtained such that the incident light is refracted at a refraction angle θ₂ at the incident surface, is incident onto the first layer, and then, is reflected by the opposing surface of the first layer, and returns to the incident surface, and is refracted by the incident surface and outputted, and
wherein the controller is configured to acquire the two-dimensional image including the light intensities of the S-polarized light components for each of the incident angles θᵢ while changing the incident angle to search for the incident angle θᵢ corresponding to a minimum value of the light intensities of the detected S-polarized light components, and to calculate and output the thickness t of the first layer of the entire plant leaf by using the following equation:
$$t = \frac{( m - \frac{1}{2} ) λ}{2 {n}_{1} cos ( {θ}_{2} )} , \qquad [ Equation 2 ]$$
and
n₀×sin θᵢ=n₁×sin θ₂,
where m is a natural number,
n₀ is a refractive index of the air layer, and
n₁ is a refractive index of the first layer.
